(19) United States
(12) Patent Application Publication
(10) Pub. No.: US 2009/0042561 A1
(43) Pub. Date: Feb. 12, 2009

(54) Asset management system

(76) Inventor: Brian Abraham Jackson, San Francisco, CA (US)

Correspondence Address: TANKHILEVICH, BORIS;Law Offices Of Boris G. Tankhilevich, Suite A, 536 N. Civic Drive, Walnut Creek, CA, 94597, US

(21) Appl. No.: 11/891,359

(22) Filed: Aug. 9, 2007

(51) Int. Cl. H04Q 7/20

(52) U.S. Cl. 455/426.1

(57) ABSTRACT

An asset management system comprising: (A) a plurality of tags, wherein at least one said tag further comprises: a wireless networking transceiver (WNT), and a tag sensor configured to attach to an asset; and (B) a dual wireless communication network further comprising: a cellular network and a Wireless Local Area Network (WLAN).

### TECHNICAL FIELD

The current invention relates to asset management systems.

### BACKGROUND ART

In the prior art, an asset management system utilized asset tags and a cellular communication technology to communicate over the air (OTA) with an asset management center (or Base Station (BS)). This cellular mode of communication results in accruing communication costs to the end user during the whole time wherein such user is engaged in tracking a status (and/or a position) of an asset connected with the tag.

In the prior art, to minimize the communication costs OTA communications are halted when an asset is in a position with a known location. However, this cost-saving approach to cut the communication costs by interrupting communications also results in interrupted communications with an asset. This might be undesirable in some instances when an asset is deemed to be valuable enough to have an uninterrupted and continuous monitoring capability even if it results in higher communication costs.

In another prior art approach, an asset management system utilized a cost free Wireless Local Area Network (WLAN) for communication between assets and/or between assets and a Base Station (BS). WLAN is a free communication system and therefore a free communication capability can be maintained at all times. The drawback to this approach is that the BS loses its ability to track assets when they are moved outside the visibility of the WLAN.

### DISCLOSURE OF THE INVENTION

The present invention discloses an asset management system that utilizes a dual wireless communication network further comprising a cellular network configured to maintain a continuous asset monitoring capability and a Wireless Local Area Network (WLAN) configured to provide a cost saving communication capability.

One aspect of the present invention is directed an asset management system comprising: (A) a plurality of tags, wherein at least one tag further comprises: a wireless networking transceiver (WNT), and a tag sensor configured to attach to an asset; and (B) a dual wireless communication network further comprising a cellular network and a Wireless Local Area Network (WLAN).

In one embodiment of the present invention, the wireless networking transceiver (WNT) further comprises: a cellular modem, and a WLAN transceiver.

In one embodiment of the present invention, the cellular modem is selected from the group consisting of: {a GSM modem; a CDMA modem; a WCDMA modem; and a GPRS modem}.

In one embodiment of the present invention, the WLAN transceiver is selected from the group consisting of: {a WiFi transceiver; a WiMAX transceiver; a Bluetooth transceiver; a Zigbee transceiver; and a UWB transceiver}.

In one embodiment of the present invention, the WLAN transceiver further comprises a RFID transmitter.

In one embodiment of the present invention, at least one tag sensor is selected from the group consisting of: {a GPS sensor; an inertial sensor; a Motion sensor; a temperature sensor; and a humidity sensor}.

In one embodiment of the present invention, the cellular network is selected from the group consisting of: {GSM; CDMA; and WCDMA}.

In one embodiment of the present invention, the Wireless Local Area Network (WLAN) further comprises: a first Access Point (AP), and a first number of tags. In this embodiment of the present invention, each tag further comprises an active node. In this embodiment of the present invention, each active node is configured to wirelessly communicate with the first AP by using a WLAN transceiver via the Wireless Local Area Network (WLAN). In this embodiment of the present invention, each active node is configured to wirelessly communicate with a Base Station (BS) via the first AP and via the cellular network.

In one embodiment of the present invention, the first Access Point is selected from the group consisting of: {a router; and a Zigbee main node}.

In one embodiment of the present invention, the Wireless Local Area Network (WLAN) further comprises a second number of tags. In this embodiment of the present invention, each tag further comprises a passive node. In this embodiment of the present invention, each passive node is configured to wirelessly communicate with the Base Station (BS) directly by using the cellular network.

In one embodiment of the present invention, if the second number of passive nodes exceeds a threshold number, one passive node is configured to become a second Access Point, and each remaining passive node is configured to become an active node configured to wirelessly communicate with the second AP by using the WLAN transceiver via the Wireless Local Area Network (WLAN), and configured to wirelessly communicate with the Base Station (BS) via the second AP and via the cellular network.

In one embodiment of the present invention, the threshold number of passive nodes further comprises a predetermined number of passive nodes.

Another aspect of the present invention is directed to a method for minimizing communication costs of asset management by using a dual wireless communication network.

In one embodiment, the method of the present invention for minimizing communication costs of asset management by using a dual wireless communication network comprises: (A) providing a plurality of tags, wherein each tag is attached to an asset, and wherein each tag further comprises a wireless networking transceiver (WNT) and a tag sensor; (B) providing the dual wireless communication network further comprising a cellular network and a cost-free Wireless Local Area Network (WLAN); and (C) managing each asset by using the dual communication system, wherein communication between each two assets is performed by using the cost-free Wireless Local Area Network (WLAN), and wherein communication between at least one asset and the BS is performed by using the cellular network.

One more aspect of the present invention is directed to a method for minimizing operational cost of asset management by using a dual wireless communication network.

In one embodiment, the method of the present invention for minimizing operational cost of asset management by using a dual wireless communication network comprises: (A) providing a plurality of tags, wherein each tag is attached to an asset, and wherein each tag further comprises a wireless networking transceiver (WNT) and a tag sensor; (B) providing the dual wireless communication network further comprising a cellular network and a cost-free self-organizing Wireless Local Area Network (WLAN); (C) selecting one tag having an optimum position location to become an Access Point (AP); and (D) managing each asset by using the dual communication system, wherein communication between each tag and the AP is performed by using the cost-free Wireless Local Area Network (WLAN), and wherein communication between the AP and the Base Station (BS) is performed by using the cellular network.

In one embodiment of the present invention, the step (C) further comprises: (C1) determining position coordinates of each tag by using the tag sensor; (C2) transmitting the position coordinates of each tag to the BS; (C3) analyzing the positioning data by the BS in order to select one tag as an AP; and (C4) selecting one tag as the AP by using a selection algorithm configured to minimize the energy consumption by the asset management system.

In one embodiment of the present invention, the step (C1) further comprises: (C1, 1) determining position coordinates of at least one tag by using a tag sensor selected from the group consisting of: {a GPS sensor; and an inertial sensor}.

In one embodiment of the present invention, the step (C) further comprises: (C5) periodically repeating the steps (C1)-(C4) to accommodate for the changes in position coordinates of each asset.

One additional more aspect of the present invention is directed to another method for minimizing operational cost of asset management by using a dual wireless communication network.

In one embodiment, the method of the present invention for minimizing operational cost of asset management by using the dual wireless communication network comprises: (A) providing a plurality of tags, wherein each tag is attached to an asset, and wherein the tag further comprises a wireless networking transceiver (WNT) and a tag sensor; (B) providing the dual wireless communication network comprising a cellular network and a cost-free self-organizing Wireless Local Area Network (WLAN); (C) calculating a number of tags; (D) determining a minimum number of Access Points (APs) based on said number of tags; (E) selecting a first tag as a first AP; (F) repeating the step (E) until the AP selection process is exhausted; and (G) managing each asset by using the dual communication system, wherein the communication between each tag and an AP is performed by using the cost-free Wireless Local Area Network (WLAN), and wherein communication between each AP and the Base Station (BS) is performed by using the cellular network.

In one embodiment of the present invention, the step (E) further comprises: (E1) determining position coordinates of each tag by using the tag sensor; (E2) transmitting the position coordinates of each tag to the BS; (E3) analyzing the positioning data by the BS; (E4) selecting each AP by using the selection algorithm configured to minimize the energy consumption by the asset management system; and (E5) periodically repeating the steps (E1)-(E4) to accommodate for the changes in position coordinates of each asset.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 depicts a general topological diagram of the asset management system of the present invention that employs dual wireless technologies to communicate with each asset tag.

FIG. 2 illustrates a topological diagram of the asset management system of the present invention that includes a Wireless Local Area Network (WLAN) further comprising a single Access Point (AP).

FIG. 3 depicts a topological diagram of the asset management system of the present invention that includes a Wireless Local Area Network (WLAN) further comprising at least two Access Points (APs).

FIG. 4 is a flow chart of the asset management algorithm of the present invention for minimizing communication costs of asset management by utilizing a dual wireless communication network.

### BEST MODE FOR CARRYING OUT THE INVENTION

Reference now will be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific-details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Some portions of the detailed descriptions which follow are presented in terms of particles and quasi-particles interactions, procedures, equations, blocks, diagrams, and other symbolic representations of physical processes. These descriptions and representations are the means used by those skilled in the art of physics of condensed matter to most effectively convey the substance of their work to others skilled in the art.

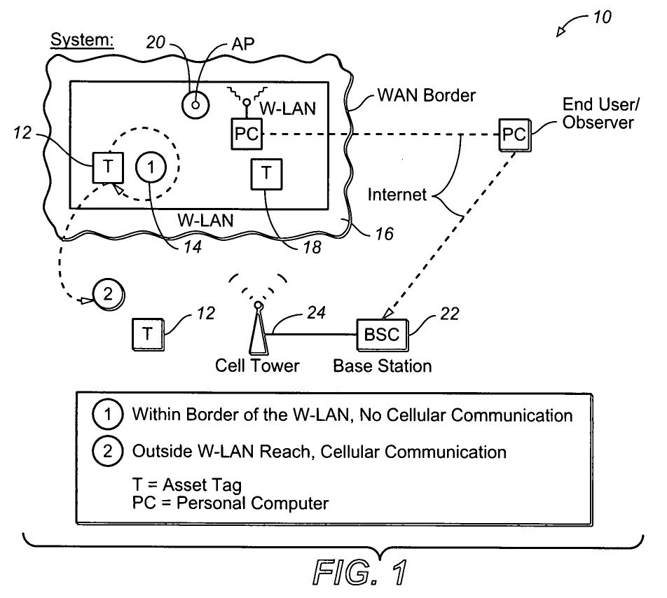

FIG. 1 depicts the general topological diagram 10 of the asset management system of the present invention that employs dual wireless technologies to communicate with each asset tag 12. If the asset tag 12 is at location 14 within the Wireless Local Area Network (WLAN) space 16, it communicates with any other tag 18 within (WLAN) space 16 or with an Access Point (AP) 20 by using a cost free Wireless Local Area Network (WLAN) technology. On the other hand, if the asset tag 12 is at location 20 outside the Wireless Local Area Network (WLAN) space 16, it communicates with the Base Station (BS) 22 via the cellular network including a cell tower 24. Thus, if tag 12 is inside the visibility of the (WLAN) space 16 the continuous monitoring can occur without incurring the communication costs of transmitting data over a cellular network.

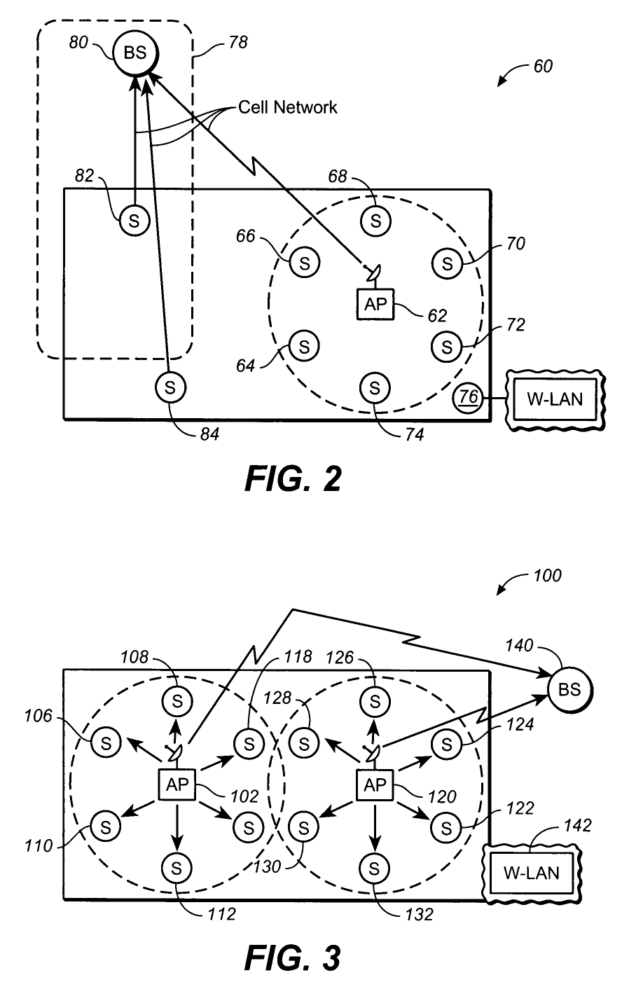

In one embodiment of the present invention, FIG. 2 illustrates a topological diagram of the asset management system of the present invention 60 that includes a Wireless Local Area Network (WLAN) further comprising a single Access Point (AP) 62 and a plurality of tags 64-74.

A wireless LAN or WLAN is a wireless local area network, which is the linking of two or more computers without using wires. WLAN utilizes spread-spectrum or OFDM (802.11a) modulation technology based on radio waves to enable communication between devices in a limited area, also known as the basic service set. This gives users the mobility to move around within a broad coverage area and still be connected to the network. The typical range of a common 802.11g network with standard equipment is on the order of tens of meters. To obtain additional range, repeaters or additional Access Points (AP) will have to be configured.

Like any radio frequency transmission, WLAN signals are subject to a wide variety of interference, as well as complex propagation effects (such as multipath). In the case of typical WLAN networks, modulation is achieved by complicated forms of phase-shift keying (PSK) or quadrature amplitude modulation (QAM), making interference and propagation effects all the more disturbing. As a result, important network resources such as servers are rarely connected wirelessly. The speed on most wireless networks (typically 1-108 Mbit/s) is reasonably slow compared to the slowest common wired networks (100 Mbit/s up to several Gbit/s). However, in most environments, a WLAN running at its slowest speed is still faster than the internet connection serving it in the first place. However, in specialized environments, the throughput of a wired network might be necessary. Newer standards such as 802.11n are addressing this limitation and will support peak throughputs in the range of 100-200 Mbit/s.

Referring still to FIG. 2, each tag (64-74) further comprises: a wireless networking transceiver (WNT) (not shown), and a tag sensor (not shown) configured to attach to an asset (not shown).

In one embodiment of the present invention, the wireless networking transceiver (WNT) (not shown) further comprises a GSM modem.

The Global System for Mobile communications (GSM: originally from Groupe Special Mobile) is the most popular standard for mobile phones in the world. GSM differs significantly from its predecessors in that both signaling and speech channels are digital call quality, and so is considered a second generation (2G) mobile phone system. The key advantage of GSM systems to consumers has been higher digital voice quality and low cost alternatives to making calls, such as the Short message service (SMS, also called “text messaging”). Like other cellular standards, GSM allows network operators to offer roaming services so that subscribers can use their phones on GSM networks all over the world. Newer versions of the standard were backward-compatible with the original GSM phones. For example, Release '97 of the standard added packet data capabilities, by means of General Packet Radio Service (GPRS). Release '99 introduced higher speed data transmission using Enhanced Data Rates for GSM Evolution (EDGE).

Referring still to FIG. 2, in one embodiment of the present invention, the wireless networking transceiver (WNT) (not shown) further comprises a CDMA modem.

Code division multiple access (CDMA) is a form of multiplexing and a method of multiple access to a physical medium such as a radio channel, where different users use the medium at the same time by using different code sequences. By contrast, time division multiple access (TDMA) divides access by time, while frequency-division multiple access (FDMA) divides it by frequency.

CDMA is a form of “spread-spectrum” signaling, since the modulated coded signal has a much higher bandwidth than the data being communicated. CDMA has been used in many communications and navigation systems, including the Global Positioning System and in the Omni TRACS satellite system for transportation logistics.

Multiplexing requires all of the users to be coordinated so that each transmits their assigned sequence v (or the complement, -v) starting at exactly the same time. Thus, this technique finds use in base-to-mobile links, where all of the transmissions originate from the same transmitter and can be perfectly coordinated. On the other hand, the mobile-to-base links cannot be precisely coordinated, particularly due to the mobility of the handsets, and require a somewhat different approach. Since it is not mathematically possible to create signature sequences that are orthogonal for arbitrarily random starting points, unique “pseudo-random” or “pseudo-noise” (PN) sequences are used in Asynchronous CDMA systems. These PN sequences are statistically uncorrelated, and the sum of a large number of PN sequences results in Multiple Access Interference (MAI) that is approximated by a Gaussian noise process. If all of the users are received with the same power level, then the variance (e.g., the noise power) of the MAI increases in direct proportion to the number of users.

All forms of CDMA use spread spectrum process gain to allow receivers to partially discriminate against unwanted signals. Signals encoded with the specified PN sequence (code) are received, while signals with different codes (or the same code but a different timing offset) appear as wideband noise reduced by the process gain.

Since each user generates MAI, controlling the signal strength is an important issue with CDMA transmitters. CDMA (Synchronous CDMA), TDMA or FDMA receiver can in theory completely reject arbitrarily strong signals using different codes, time slots or frequency channels due to the orthogonality of these systems. This is not true for Asynchronous CDMA; rejection of unwanted signals is only partial. If any or all of the unwanted signals are much stronger than the desired signal, they will overwhelm it. This leads to a general requirement in any Asynchronous CDMA system to approximately match the various signal power levels as seen at the receiver. In CDMA cellular, the base station uses a fast closed-loop power control scheme to tightly control each mobile's transmit power. Most importantly, Asynchronous CDMA offers a key advantage in the flexible allocation of resources. Asynchronous CDMA transmitters simply send when they have something to say, and go off the air when they don't, keeping the same PN signature sequence as long as they are connected to the system. In other words, Asynchronous CDMA is ideally suited to a mobile network where large numbers of transmitters each generate a relatively small amount of traffic at irregular intervals.

Referring still to FIG. 2, in one embodiment of the present invention, the wireless networking transceiver (WNT) (not shown) further comprises a WCDMA modem.

WCDMA (Wideband Code Division Multiple Access) is a type of 3G cellular network. WCDMA is the higher speed transmission protocol used in the Japanese FOMA system and in the UMTS system, a third generation follow-on to the 2G GSM networks deployed worldwide.

More technically, WCDMA is a wideband spread-spectrum mobile air interface that utilizes the direct sequence Code Division Multiple Access signaling method (or CDMA) to achieve higher speeds and support more users compared to the implementation of time division multiplexing (TDMA) used by 2G GSM networks. WCDMA transmits on a pair of 5 MHz wide radio channels, while CDMA2000 transmits on one or several pairs of 1.25 MHz radio channels. WCDMA has been developed into a complete set of specifications, a detailed protocol that defines how a mobile phone communicates with the tower, how signals are modulated, how data grams are structured, and system interfaces are specified allowing free competition on technology elements. The world's first commercial WCDMA service, FOMA, was launched by NTT DoCoMo in Japan in 2001. Elsewhere, WCDMA deployments have been exclusively UMTS based.

Referring still to FIG. 2, in one embodiment of the present invention, the wireless networking transceiver (WNT) (not shown) further comprises a GPRS modem.

General Packet Radio Service (GPRS) is a Mobile Data Service available to users of Global System for Mobile Communications (GSM) and IS-136 mobile phones. GPRS data transfer is typically charged per megabyte of transferred data, while data communication via traditional circuit switching is billed per minute of connection time, independent of whether the user has actually transferred data or has been in an idle state. GPRS can be used for services such as Wireless Application Protocol (WAP) access, Short Message Service (SMS), Multimedia Messaging Service (MMS), and for Internet communication services such as email and World Wide Web access.

GPRS is packet-switched, which means that multiple users share the same transmission channel, only transmitting when they have data to send. Thus the total available bandwidth can be immediately dedicated to those users who are actually sending at any given moment, providing higher use where users only send or receive data intermittently. Web browsing, receiving e-mails as they arrive and instant messaging are examples of uses that require intermittent data transfers, which benefit from sharing the available bandwidth. By contrast, in the older Circuit Switched Data (CSD) standard included in GSM standards, a connection establishes a circuit, and reserves the full bandwidth of that circuit during the lifetime of the connection.

Referring still to FIG. 2, in one embodiment of the present invention, each tag (64-74) further comprises a wireless networking transceiver (WNT) (not shown) further comprising a WLAN transceiver selected from the group consisting of: {a WiFi transceiver; a WiMax transceiver; a Bluetooth transceiver; a Zigbee transceiver; and a UWB transceiver}.

Wi-Fi was originally a brand licensed by the Wi-Fi Alliance to describe the embedded technology of wireless local area networks (WLAN) based on the IEEE 802.11 standard. As of 2007, common use of the term Wi-Fi has broadened to describe the generic wireless interface of mobile computing devices, such as laptops in LANs. Common uses for Wi-Fi include Internet and VoIP phone access, gaming, and network connectivity for consumer electronics such as televisions, DVD players, and digital cameras.

Referring still to FIG. 2, in one embodiment of the present invention, each tag (64-74) further comprises a wireless networking transceiver (WNT) (not shown) further comprising a WiMAX transceiver.

WiMAX, the Worldwide Interoperability for Microwave Access, is a telecommunications technology aimed at providing wireless data over long distances in a variety of ways, from point-to-point links to full mobile cellular type access. It is based on the IEEE 802.16 standard, which is also called Wireless MAN. WiMAX allows a user, for example, to browse the Internet on a laptop computer without physically connecting the laptop to a wall jack. The name WiMAX was created by the WiMAX Forum, which was formed in June 2001 to promote conformance and interoperability of the standard. The forum describes WiMAX as “a standards-based technology enabling the delivery of last mile wireless broadband access as an alternative to cable and DSL.” In areas without pre-existing physical cable or telephone networks, WiMAX may be a viable alternative for broadband access that has been economically unavailable. Prior to WiMAX, many operators have been using proprietary fixed wireless technologies for broadband services.

Referring still to FIG. 2, in one embodiment of the present invention, each tag (64-74) further comprises a wireless networking transceiver (WNT) (not shown) further comprising a Bluetooth transceiver.

Bluetooth is an industrial specification for wireless personal area networks (PANs). Bluetooth provides a way to connect and exchange information between devices such as mobile phones, laptops, PCs, printers, digital cameras, and video game consoles over a secure, globally unlicensed short-range radio frequency. The Bluetooth specifications are developed and licensed by the Bluetooth Special Interest Group. Bluetooth is a radio standard and communications protocol primarily designed for low power consumption, with a short range based on low-cost transceiver microchips in each device. Bluetooth lets these devices communicate with each other when they are in range. The devices use a radio communications system, so they do not have to be in line of sight of each other, and can even be in other rooms, as long as the received transmission is powerful enough.

Referring still to FIG. 2, in one embodiment of the present invention, each tag (64-74) further comprises a wireless networking transceiver (WNT) (not shown) further comprising a Zigbee transceiver.

Zigbee is the name of a specification for a suite of high level communication protocols using small, low-power digital radios based on the IEEE 802.15.4 standard for wireless personal area networks (WPANs). Zigbee is targeted at RF applications that require a low data rate, long battery life, and secure networking.

The relationship between IEEE 802.15.4-2003 and Zigbee is similar to that between IEEE 802.11 and the Wi-Fi Alliance. Zigbee operates in the industrial, scientific and medical (ISM) radio bands; 868 MHz in Europe, 915 MHz in the USA and 2.4 GHz in most jurisdictions worldwide. The technology is intended to be simpler and cheaper than other WPANs such as Bluetooth. The most capable Zigbee node type is said to require only about 10% of the software of a typical Bluetooth or Wireless Internet node, while the simplest nodes are about 2%. Zigbee protocols are intended for use in embedded applications requiring low data rates and low power consumption.

Referring still to FIG. 2, in one embodiment of the present invention, each tag (64-74) further comprises a wireless networking transceiver (WNT) (not shown) further comprising a UWB transceiver. UWB Ultra-wideband (UWB, ultra-wide band, ultraband, etc.) is a radio technology that can be used for short-range high-bandwidth communications by using a large portion of the radio spectrum in a way that doesn't interfere with other more traditional ‘narrow band’ uses. It also has applications in radar imaging, precision positioning and tracking technology.

Ultra-Wideband (UWB) may be used to refer to any radio technology having bandwidth exceeding the lesser of 500 MHz or 20% of the arithmetic center frequency, according to Federal Communications Commission (FCC). Each pulse in a pulse-based UWB system occupies the entire UWB bandwidth, thus reaping the benefits of relative immunity to multipath fading (but not to intersymbol interference), unlike carrier-based systems that are subject to both deep fades and intersymbol interference. Channelization (sharing the channel with other links) is a complex problem subject to many practical variables. Typically two UWB links can share the same spectrum by using orthogonal time-hopping codes for pulse-position (time-modulated) systems, or orthogonal pulses and orthogonal codes for fast-pulse based systems.

Referring still to FIG. 2, in one embodiment of the present invention, the WLAN transceiver (not shown) further comprises a RFID transmitter.

Radio-frequency identification (RFID) is an automatic identification method, relying on storing and remotely retrieving data using devices called RFID tags or transponders. An RFID tag is an object that can be stuck on or incorporated into a product, animal, or person for the purpose of identification using radio waves. Some tags can be read from several meters away and beyond the line of sight of the reader.

Most RFID tags contain at least two parts. One is an integrated circuit for storing and processing information, modulating and demodulating a (RF) signal and perhaps other specialized functions. The second is an antenna for receiving and transmitting the signal. A technology called chip less RFID allows for discrete identification of tags without an integrated circuit, thereby allowing tags to be printed directly onto assets at lower cost than traditional tags. Today, a significant thrust in RFID use is in enterprise supply chain management, improving the efficiency of inventory tracking and management.

In this embodiment of the present invention, referring still to FIG. 2, each tag (64-74) further comprises an active node. In this embodiment of the present invention, each active node is configured to wirelessly communicate with the first AP 62 by using a WLAN transceiver via the Wireless Local Area Network (WLAN). In this embodiment of the present invention, each active node is configured to wirelessly communicate with the Base Station (BS) 80 via the first AP 62 and via the cellular network 78.

In one embodiment of the present invention, the first Access Point (AP) 62 is selected from the group consisting of: {a router; and a Zigbee main node}. There are three different types of a Zigbee device.

(1) Zigbee coordinator (ZC): The most capable device, the coordinator forms the root of the network tree and might bridge to other networks. There is exactly one Zigbee coordinator in each network since it is the device that started the network originally. It is able to store information about the network, including acting as the Trust Centre & repository for security keys.

(2) Zigbee Router (ZR): As well as running an application function a router can act as an intermediate router, passing data from other devices.

(3) Zigbee End Device (ZED): Contains just enough functionality to talk to its parent node (either the coordinator or a router); it cannot relay data from other devices. This relationship allows the node to be asleep a significant amount of the time thereby giving you the much quoted long battery life. A ZED requires the least amount of memory, and therefore can be less expensive to manufacture than a ZR or ZC.

Referring still to FIG. 2, in one embodiment of the present invention, a tag (64-74) further includes a tag sensor (not shown) selected from the group consisting of: {a GPS sensor; an inertial sensor; a Motion sensor; a temperature sensor; and a humidity sensor}.

More specifically, a tag sensor can be employed to track an asset within the WLAN space (76 of FIG. 2), or outside the WLAN space. If an asset is within the WLAN space, it can be accessed via AP 62 using the cost free WLAN network. If, on the other hand, an asset is located outside the WLAN space 76, it can be accessed from the BS 80 by using the cellular network and there is a cost associated with this access.

An asset can be also moved from location within WLAN to the location outside WLAN based on temperature and/or humidity reading if the asset is temperature and/or humidity sensitive.

Some tag sensors (a GPS sensor, an inertial sensor, or/and a Motion sensor) can be used to determine a real-time location of an asset.

Referring still to FIG. 2, in one embodiment of the present invention, the Wireless Local Area Network (WLAN) further comprises a second number of tags 82 and 84. These tags 82 and 84 comprise passive node. In this embodiment of the present invention, each passive node 82 and/or 84 is configured to wirelessly communicate with the Base Station (BS) 80 directly by using the cellular network 78. This communication is not cost free.

However, if, as shown in FIG. 3, the second number of passive nodes 82 and 84 of FIG. 2) exceeds a threshold number, one passive node 102 can be selected as a second Access Point (AP), and each remaining passive node 106, 108, 110, 112, etc. becomes an active node configured to wirelessly communicate with the second AP 102 by using the WLAN transceiver via the Wireless Local Area Network (WLAN), and configured to wirelessly communicate with the Base Station (BS) 140 via the second AP 102 and via the cellular network. The relationship between the topological diagrams of FIG. 2 and FIG. 3 is as follows: the first AP 120 of FIG. 3 is the same AP 62 of FIG. 2, and a plurality of tags 122-132 are the same tags 64-74 of FIG. 2.

Another aspect of the present invention is directed to a method for minimizing communication costs of asset management by using a dual wireless communication network.

In one embodiment, the method of the present invention for minimizing communication costs of asset management by using a dual wireless communication network comprises (not shown): (A) providing a plurality of tags (64-74 of FIG. 2), wherein each tag is attached to an asset, and wherein each tag further comprises a wireless networking transceiver (WNT) and a tag sensor; (B) providing the dual wireless communication network further comprising a cellular network (78 of FIG. 2) and a cost-free Wireless Local Area Network (WLAN) (76 of FIG. 2); and (C) managing each asset by using the dual communication system, wherein communication between each two assets is performed by using the cost-free Wireless Local Area Network (WLAN), and wherein communication between each asset and the BS (80 of FIG. 2) is performed by using the cellular network.

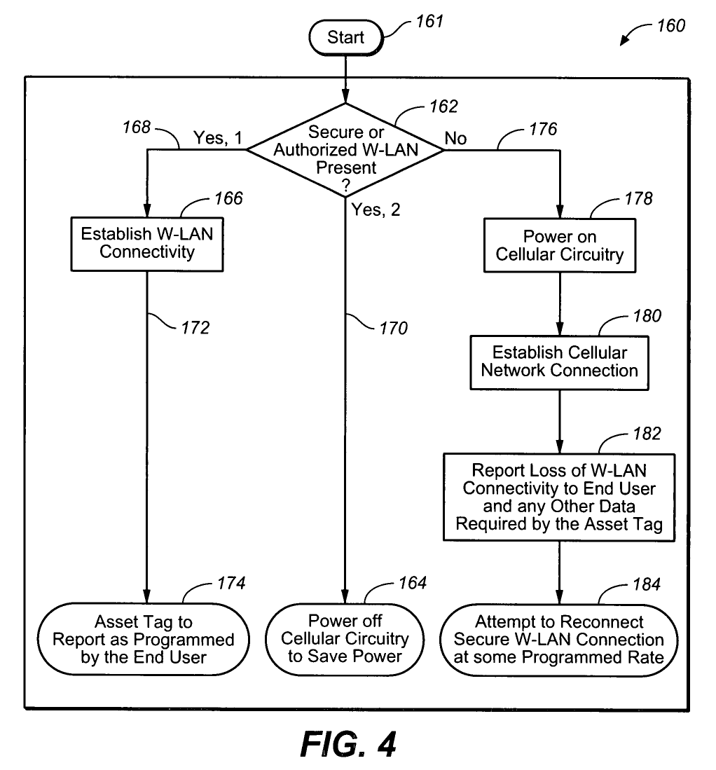

In one embodiment, the method of the present invention for minimizing communication costs of asset management by using a dual wireless communication network can be implemented by using the asset management algorithm 160 of FIG. 4.

More specifically, if the main test condition “Is secure or authorized WLAN network is present?” is satisfied, the next step 166 is to follow the logical arrow “Yes, 1” 168 and to establish WLAN connectivity. At the same time, the next step 174 is follow the logical arrow “Yes, 2” 170 and to cut the power off the cellular circuitry (78 of FIG. 2). This is the essence of the current invention- to save on cellular communications after the WLAN connectivity between the nodes (64-74 of FIG. 2) is established that allows a cost free communication between nodes (64-74 of FIG. 2) via the WLAN (76 of FIG. 2).

The next step 174 is to program the assets (nodes 64-74) to report their status to the end user (AP 62 of FIG. 2) cost-free within the WLAN space (76 of FIG. 2). If, on the other hand, the program requires the assets to report their status outside the WLAN space (76 of FIG. 2), than the cellular circuitry is powered on (step 178), and the cellular network connection is established (step 180), and the asset nodes report their status to the end user (for example, to the BS 80 of FIG. 2), or any other information can be reported to the end user (BS 78 of FIG. 2) including the loss (or absence) of WLAN connectivity (for nodes 82 and 84). At the next step 184 the attempt is made to reconnect WLAN. This can be done, for example, in order to connect (the initially disconnected) nodes to second AP after the number of disconnected nodes exceeds a predetermined number threshold (as shown in FIG. 3). This step can be performed by a self-organizing network as explained below.

Indeed, if the WLAN network of tags is capable of changing from a single AP to a multiple AP network it is a self-organizing network. In one embodiment of the present invention, a self-organizing WLAN network can be implemented by using a Zigbee's general-purpose, inexpensive, self-organizing, mesh network. Such self-organizing WLAN network can be implemented by using proactive and/or reactive protocols. Proactive routing protocols are derived from legacy Internet distance-vector and link-state protocols. They attempt to maintain consistent and updated routing information for every pair of network nodes by propagating, proactively, route updates at fixed time intervals. In contrast, reactive protocols establish the route to a destination only when requested.

In addition to proactive and reactive protocols, other classes of protocols can be used to implement a self-organizing WLAN network. For example: (a) hybrid protocols combine both proactive and reactive approaches, thus trying to bring together their advantages; (b) location-aware routing protocols use the node positions for data forwarding; (c) energy-aware routing protocols take into consideration the energy available in the network nodes to select the paths for data forwarding.

In one embodiment of the present invention, the step 184 of FIG. 4 can be performed by using a selection algorithm that selects one of nodes as a second AP (102 of FIG. 3). The selection algorithm can be utilized after the necessary info is collected by performing the following steps: (C1) determining position coordinates of each tag by using the tag sensor; (C2) transmitting the position coordinates of each tag to the BS; and (C3) analyzing the positioning data by the BS in order to select one tag as an AP.

In one embodiment of the present invention, the step (C1) further comprises: (C1, 1) determining position coordinates of at least one tag by using a tag sensor selected from the group consisting of: {a GPS sensor; and an inertial sensor}.

In one embodiment of the present invention, the selection algorithm is updated after the position coordinates of assets are updated (to be current) by performing the step (C5): periodically repeating the steps (C1)-(C4) to accommodate for the changes in position coordinates of each asset.

The foregoing descriptions of specific embodiments of the present invention have been presented for purposes of illustration and description. They are not intended to be exhaustive or to limit the invention to the precise forms disc losed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. An asset management system comprising:
(A) a plurality of tags, at least one said tag further comprising:
a wireless networking transceiver (WNT);
and
a tag sensor; each said tag sensor configured to attach to an asset;
and
(B) a dual wireless communication network; said dual wireless communication network further comprising: a cellular network and a Wireless Local Area Network (WLAN).

2. The system of claim 1, wherein said wireless networking transceiver (WNT) further comprises:
a cellular modem;
and
a WLAN transceiver.

3. The system of claim 2, wherein said cellular modem is selected from the
group consisting of: {a GSM modem; a CDMA modem; a WCDMA modem; and a GPRS modem}.

4. The system of claim 2, wherein said WLAN transceiver is selected from the group consisting of: {a WiFi transceiver; a WiMax transceiver; a Bluetooth transceiver; a Zigbee transceiver; and a UWB transceiver}.

5. The system of claim 2, wherein said WLAN transceiver further comprises:
a RFID transmitter.

6. The system of claim 1, wherein at least one said tag sensor is selected from the group consisting of: {a GPS sensor; an inertial sensor; a Motion sensor; a temperature sensor; and a humidity sensor}.

7. The system of claim 1, wherein said cellular network is selected from the group consisting of: {GSM; CDMA; and WCDMA}.

8. The system of claim 1, wherein said Wireless Local Area Network (WLAN) further comprises:
a first Access Point (AP);
and
a first number of tags, each said tag further comprising an active node, wherein each said active node is configured to wirelessly communicate with said first AP by using a WLAN transceiver via said Wireless Local Area Network (WLAN), and wherein each said active node is configured to wirelessly communicate with a Base Station (BS) via said first AP and via said cellular network.

9. The system of claim 8, wherein said first Access Point is selected from the group consisting of: {a router; and a Zigbee main node}.

10. The system of claim 8, wherein said Wireless Local Area Network (WLAN) further comprises:
a second number of tags; each said tag further comprising a passive node, each said passive node is configured to wirelessly communicate with said Base Station (BS) directly by using said cellular network.

11. The system of claim 10, wherein if said second number of passive nodes exceeds a threshold number, one said passive node is configured to become a second Access Point, and wherein each said remaining passive node is configured to become an active node configured to wirelessly communicate with said second AP by using said WLAN transceiver via said Wireless Local Area Network (WLAN), and configured to wirelessly communicate with said Base Station (BS) via said second AP and via said cellular network.

12. The system of claim 11, wherein said threshold number further comprises:
a predetermined number.

13. A method of minimizing communication costs of asset management by using a dual wireless communication network, said method comprising:
(A) providing a plurality of tags; each said tag being attached to an asset; said tag further comprising a wireless networking transceiver (WNT) and a tag sensor;
(B) providing said dual wireless communication network; said dual wireless communication network further comprising a cellular network and a cost-free Wireless Local Area Network (WLAN);
and
(C) managing each said asset by using said dual communication system; wherein communication between each two said assets is performed by using said cost-free Wireless Local Area Network (WLAN); and wherein communication between each said asset and said BS is performed by using said cellular network.

14. A method of minimizing operational cost of asset management by using a dual wireless communication network, said method comprising:
(A) providing a plurality of tags; each said tag being attached to an asset; said tag further comprising a wireless networking transceiver (WNT) and a tag sensor;
(B) providing said dual wireless communication network; said dual wireless communication network further comprising a cellular network and a cost-free self-organizing Wireless Local Area Network (WLAN);
(C) selecting one said tag having an optimum position location to become an Access Point (AP);
and
(D) managing each said asset by using said dual communication system; wherein communication between each said tag and said AP is performed by using said cost-free Wireless Local Area Network (WLAN); and wherein communication between said AP and said Base Station (BS) is performed by using said cellular network.

15. The method of claim 14, wherein said step (C) further comprises:
(C1) determining position coordinates of each said tag by using said tag sensor;
(C2) transmitting said position coordinates of each said tag to said BS;
(C3) analyzing said positioning data by said BS in order to select one said tag to become said AP;
and
(C4) selecting one said tag to become said AP by using a selection algorithm configured to minimize energy consumption by said asset management system.

16. The method of claim 15, wherein said step (C1) further comprises:
(C1, 1) determining position coordinates of at least one said tag by using a tag sensor selected from the group consisting of: {a GPS sensor; and an inertial sensor}.

17. The method of claim 15 further comprising:
(C5) periodically repeating said steps (C1)-(C4) to accommodate for the changes in position locations of each said asset.

18. A method of minimizing operational cost of asset management by using a dual wireless communication network, said method comprising:
(A) providing a plurality of tags; each said tag being attached to an asset; said tag further comprising a wireless networking transceiver (WNT) and a tag sensor;
(B) providing said dual wireless communication network; said dual wireless communication network further comprising a cellular network and a cost-free self-organizing Wireless Local Area Network (WLAN);
(C) calculating a number of tags;
(D) determining a minimum number of Access Points (APs) based on said number of tags;
(E) selecting a first tag to become a first AP;
(F) repeating said step (E) until said AP selection process is exhausted;
and
(G) managing each said asset by using said dual communication system, wherein communication between each said tag and one said AP is performed by using said cost-free Wireless Local Area Network (WLAN), and wherein communication between each said AP and said Base Station (BS) is performed by using said cellular network.

19. The method of claim 18, wherein said step (E) further comprises:
(E1) determining position coordinates of each said tag by using said tag sensor;
(E2) transmitting said position coordinates of each said tag to said BS;
(E3) analyzing said positioning data by said BS;
and
(E4) selecting each said AP by using a selection algorithm configured to minimize the energy consumption by said asset management system.

20. The method of claim 19 further comprising:
(E5) periodically repeating said steps (E1)-(E4) to accommodate for the changes in position coordinates of each said asset.
